(19) United States
(12) Patent Application Publication
(10) Pub. No.: US 2014/0055381 A1
(43) Pub. Date: Feb. 27, 2014

(54) SYSTEM AND CONTROL METHOD FOR CHARACTER MAKE-UP

(71) Applicant: INDUSTRY FOUNDATION OF CHONNAM NATIONAL UNIVERSITY, Gwangju (KR)

(72) Inventors: Jin Young Kim, Jeollanam-do (KR); Joo Young Park, Gwangju (KR); Chil Woo Lee, Gwangju (KR); Do Sung Shin, Gwangju (KR); Seung You Na, Gwangju (KR)

(73) Assignee: INDUSTRY FOUNDATION OF CHONNAM NATIONAL UNIVERSITY, Gwangju (KR)

(21) Appl. No.: 13/702,078

(22) PCT Filed: Nov. 12, 2012
(86) PCT No.: PCT/KR12/09525

§ 371 Date: Dec. 5, 2012

(30) Foreign Application Priority Data
May 14, 2012 (KR) 10-2012-0051005
Sep. 14, 2012 (KR) 10-2012-0102107

(51) Int. Cl. G06F 3/023; G06F 3/0488; G06F 3/01

(52) U.S. Cl. CPC G06F 3/0236; G06F 3/017; G06F 3/0488
USPC 345/173; 345/156

(57) ABSTRACT

The present invention relates, in general, to a method of conveniently making up a character string in smart phone-based messengers or Internet-based Social Network Services (SNSs) by utilizing technology for implementing a user-friendly interface using multi-touch, a gyro sensor, etc.

### CROSS REFERENCE TO RELATED APPLICATIONS AND CLAIM OF PRIORITY

This patent application claims benefit under 35 U.S.C. 119(e), 120, 121, or 365(c), and is a National Stage entry from International Application No. PCT/KR2012/009525, filed on Nov. 12, 2012, which claims priority to Korean Patent Application Nos. 10-2012-0051005, filed May 14, 2012, and 10-2012-0102107, filed Sep. 14, 2012, entire contents of which are incorporated herein by reference.

### BACKGROUND

1. Technical Field

The present invention relates, in general, to a method of conveniently making up a character string in smart phone-based messengers or Internet-based Social Network Services (SNSs) by utilizing technology for implementing a user-friendly interface using multi-touch, a gyro sensor, etc.

2. Description of the Related Art

Generally, with the development of smart phones, messengers that were configured to simply transmit only characters have recently developed into providing Social Network Services (SNSs) (for example, KakaoTalk, Facebook, Twitter, etc.) in combination with the Internet.

The combination of smart phones with SNSs has evolved smart phones so that services are provided up to a stage in which human relationships between smart phone users are established and maintained, but the entry, transmission, and display of messages (character strings) do not yet exceed the level of existing feature phones. Since characters have a uniform character shape and uniform tone, such as a single color, it is impossible to change characters in conformity with various sentiments and requirements of smart phone users. For example, FIG. 1 shows the execution window of the existing KakaoTalk, wherein all character strings share the same font and color.

However, nowadays, with the number of smart phone users having greatly increased, technology for changing messages into which emotions, sentiments, emphasis, etc. of users can be incorporated is required in consideration of various sentiments and requirements of the users.

Meanwhile, the environment of a smart phone is very different from that of a Personal Computer (PC). Such a smart phone has a smaller screen than that of a PC monitor and is not equipped with input/output devices, such as a mouse and a keyboard, as in the case of a PC. In the PC, various fonts, character styles, etc. are provided to a document editor, and characters can be easily represented using a mouse or the like. However, such a method cannot be adopted by a smart phone. Therefore, an intuitive, simple, and convenient interface method must be presented so as to represent messages on the smart phone.

### SUMMARY

The present invention for solving the above problems is intended to provide technology for making up character strings in a document editor, a messenger, or an SNS on a terminal, such as a smart phone, and an object of the present invention is to provide character string makeup in consideration of an interface environment used in a terminal, such as a smart phone and a desktop computer, and to enable characters that are provided by a PC to be represented.

Another object of the present invention is to enable messages that are transmitted and received to be represented in various formats even on a terminal such as a smart phone and a desktop computer without having a mouse or keyboard as in the case of a PC, wherein, for this function, first, this technology must be very intuitive, second, the use of technology must be simplified, and third, this technology must be able to be implemented using only a basic interface means provided by a terminal, such as a smart phone and a desktop computer.

A further object of the present invention is to configure an optimal interface window when the small display of a smart phone is taken into consideration.

Yet another object of the present invention is to use a convenient input means based on a touch or motion sensor (a gyro sensor or an acceleration sensor).

Still another object of the present invention is to provide a function that enables various characters and messages to be made up in proportion to the number of various users.

Still another object of the present invention is intended to prevent a provided interface from unnecessarily occupying smart phone resources using complicated computation, excessive memory, or the like.

Still another object of the present invention is to implement character makeup so that characters are made up in accordance with a user's sentiment by changing the font of characters (font makeup), the color of characters, or the style (bold, italic, or the like) of characters, or changing the characters in various other manners when the characters are made up.

In order to accomplish the above objects, the present invention provides a method of controlling a character makeup terminal, including a gesture sensing data storage step of storing gesture sensing data including one or more of touch gesture sensing data sensed by a touch gesture sensor and motion gesture sensing data sensed by a motion gesture sensor, in a data storage unit; a character makeup setting data reading step of reading character makeup setting data, set in accordance with the gesture sensing data, from the data storage unit; a character makeup data conversion step of a gesture makeup controller converting character data depending on the character makeup setting data read at the character makeup setting data reading step; and a converted data display step of a makeup display data processing unit processing converted character data so as to display the character data on a display.

Further, the present invention provides a method of controlling a character makeup terminal, including a gesture sensing data storage step of storing gesture sensing data including one or more of touch gesture sensing data sensed by a touch gesture sensor and obtained by analyzing a pattern of a movement trajectory of a touch using a touch gesture recognizer and motion gesture sensing data sensed by a motion gesture sensor and obtained by analyzing a pattern of a movement trajectory of a terminal motion using a motion gesture recognizer, in a data storage unit; a character makeup setting data reading step of reading character makeup setting data, set in accordance with a predetermined pattern of the movement trajectory of the touch or a predetermined pattern of the movement trajectory of the terminal motion, from the data storage unit with respect to the gesture sensing data including one or more of the touch gesture sensing data and the motion gesture sensing data; a character makeup data conversion step of a gesture makeup controller converting character data depending on the character makeup setting data read at the character makeup setting data reading step; and a converted data display step of a makeup display data processing unit processing converted character data so as to display the character data on a display.

In a preferred embodiment of the present invention, the method may further include a character makeup data transfer step of displaying the character data on the display and allowing a message conversion unit to convert the character data into text message data and transfer the text message data by processing a selection input signal on a transfer window.

Further, in a preferred embodiment of the present invention, the character makeup data transfer step may include a mark-up processing step of converting the text message data converted from the character data for character makeup into an abbreviated transfer language.

Furthermore, in a preferred embodiment of the present invention, the method may further include a character display step of displaying characters including a target character that is a target of character makeup on the display; and a conversion target selection step of storing information about selection of the target character that is the target of character makeup among the characters displayed on the display in a DB.

Furthermore, in a preferred embodiment of the present invention, the character makeup data conversion step may include one or more of a character color conversion step of converting and processing a color of a target character; a character font conversion step of converting and processing a font of the target character; a character size conversion step of converting and processing a size of the target character; a character style conversion step of converting and processing a style of the target character; a character string wave pattern conversion step of converting and processing a shape of a character string including the target character into a wave pattern; and a scrambling step of randomly arranging a sequence of words by scrambling and processing a character string including the target character.

Furthermore, in a preferred embodiment of the present invention, the character makeup data conversion step may include a character color conversion step of converting and processing a color of a target character, the gesture sensing data storage step may be configured such that gesture sensing data required to convert and process the color of the target character is stored in the data storage unit, and when the gesture sensing data required to convert the color of the target character is input by the gesture makeup controller, a color selection window required to select and input a color of characters may be displayed on the display.

Furthermore, in a preferred embodiment of the present invention, the character makeup data conversion step may include a character font conversion step of converting and processing a font of a target character, the gesture sensing data storage step may be configured such that gesture sensing data required to convert and process the font of the target character is stored in the data storage unit, and when the gesture sensing data required to convert the font of the target character is input by the gesture makeup controller, a font selection window required to select and input a font may be displayed on the display.

In addition, the present invention provides a character makeup terminal including a character display window for displaying a target character that is a target of character makeup among displayed characters; and a touch input window for sensing a touch gesture action via manipulation of a user so as to perform character makeup on the target character that is the target of character makeup among the characters displayed on the character display window.

Further, the present invention provides a character makeup terminal including a gesture makeup controller for performing character makeup to convert a target character displayed on a character display window of a display, wherein the gesture makeup controller reads character makeup setting data, set in accordance with gesture sensing data corresponding to one or more of touch sensing data and motion sensing data, from a data storage unit, and converts character data of the target character depending on the read character makeup setting data.

In a preferred embodiment of the present invention, the character makeup terminal may further include a touch gesture sensor for sensing a touch input of a user from a touch input window; a touch gesture recognizer for receiving sensing data of the touch input sensed by the touch gesture sensor, and calculating touch gesture sensing data by analyzing a pattern of a movement trajectory of the touch; a motion gesture sensor for sensing a motion of the user; a motion gesture recognizer for receiving sensing data of the motion sensed by the motion gesture sensor, and calculating motion gesture sensing data by analyzing a pattern of a movement trajectory of the motion; and a data storage unit for storing gesture sensing data including one or more of the touch gesture sensing data and the motion gesture sensing data, and storing character makeup setting data set in accordance with the gesture sensing data.

Further, in a preferred embodiment of the present invention, the character display window may be configured such that a target character of a displayed character string is displayed as a target character converted by the gesture makeup controller.

Further, in a preferred embodiment of the present invention, the touch input window may be located in part of a display area of the display, or in an entire display area of the display.

Furthermore, in a preferred embodiment of the present invention, the character makeup terminal may further include a touch input window active area for activating the touch input window for character makeup of the target character; and a touch input hiding area for preventing an activated touch input window from being displayed on the display by deactivating the activated touch input window.

Furthermore, in a preferred embodiment of the present invention, the character makeup terminal may further include a message conversion unit for transferring a character displayed on the character display window; and a transfer window for receiving a signal causing the character to be transferred by the message conversion unit.

### BRIEF DESCRIPTION OF DRAWINGS

FIG. 1 is a diagram illustrating a screen on which text messages are executed on a smart terminal;

FIG. 2 is a diagram illustrating the execution of a text message writing screen on a character makeup terminal according to the present invention;

FIG. 3 is a diagram illustrating the execution of character makeup on the character makeup terminal according to the present invention;

FIG. 4 is a diagram illustrating the execution of character makeup in a state in which a touch screen hiding operation is applied to the character makeup terminal according to the present invention;

FIG. 5 is a diagram illustrating the writing sequence of character makeup on the character makeup terminal according to the present invention;

FIG. 6 is a diagram illustrating a touch input action table for character makeup on the character makeup terminal according to the present invention;

FIG. 7 is a diagram illustrating terminal motion sensing actions and a sensing table for character makeup on the character makeup terminal according to the present invention;

FIG. 8 is a diagram illustrating a table indicating character makeup examples depending on touch input for character makeup on the character makeup terminal according to the present invention;

FIG. 9 is a diagram illustrating a table indicating character makeup examples depending on terminal motion sensing for character makeup on the character makeup terminal according to the present invention;

FIG. 10 is a diagram illustrating a mark-up processing table, in which a made-up-text message is converted into an abbreviated transfer language, on the character makeup terminal according to the present invention;

FIG. 11 is a diagram illustrating a color conversion table applied to character makeup on the character makeup terminal according to the present invention;

FIG. 12 is a diagram illustrating a character font conversion table applied to character makeup on the character makeup terminal according to the present invention;

FIG. 13 is a diagram illustrating a table in which a character string is converted into a wave pattern and which is applied to character makeup on the character makeup terminal according to the present invention;

FIG. 14 is a diagram illustrating the sequence of a color conversion procedure in character makeup on the character makeup terminal according to the present invention;

FIG. 15 is a control configuration diagram showing the character makeup terminal according to the present invention;

FIG. 16 is a flowchart showing a method of controlling the character makeup terminal according to the present invention;

FIG. 17 is a diagram illustrating the color conversion processing procedure of character makeup on the character makeup terminal according to the present invention; and

FIG. 18 is a diagram illustrating the font conversion processing procedure of character makeup on the character makeup terminal according to the present invention.

### DETAILED DESCRIPTION

Hereinafter, the present invention will be described in detail with reference to the attached drawings.

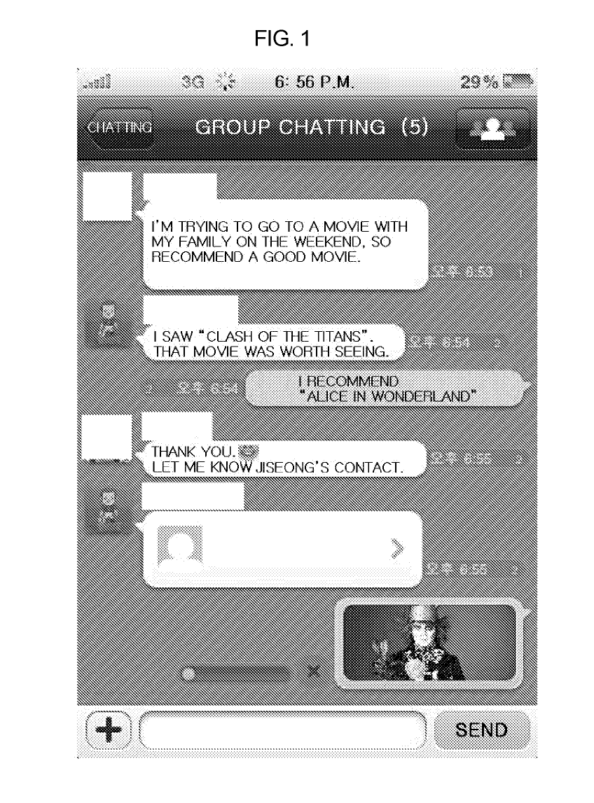

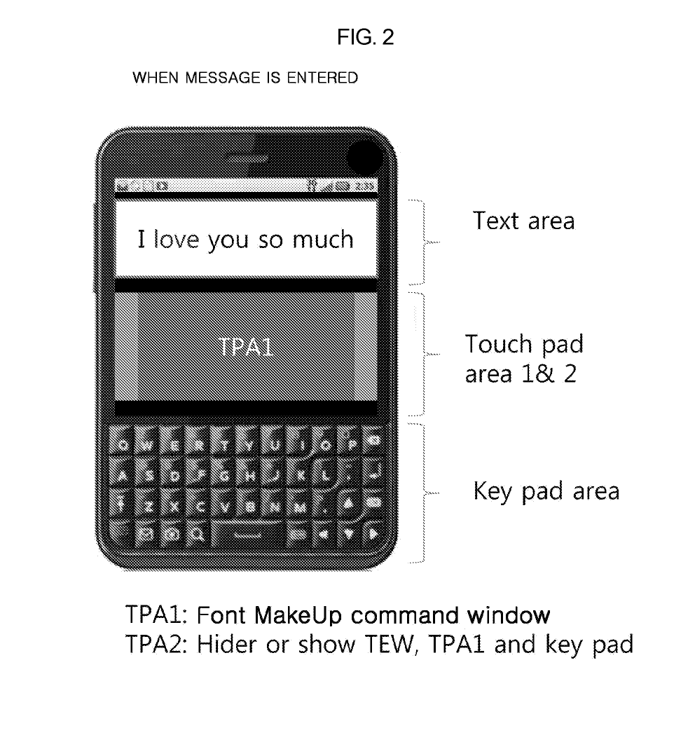

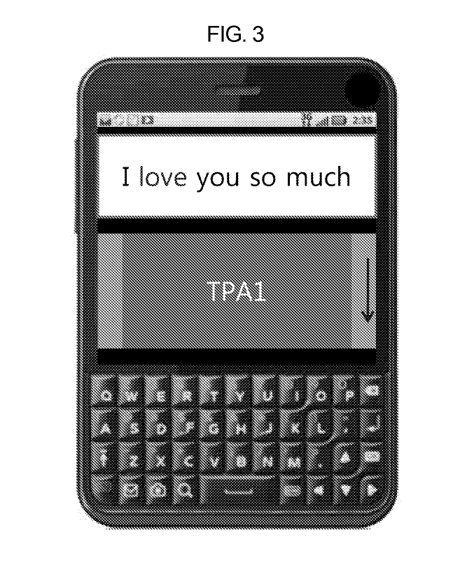

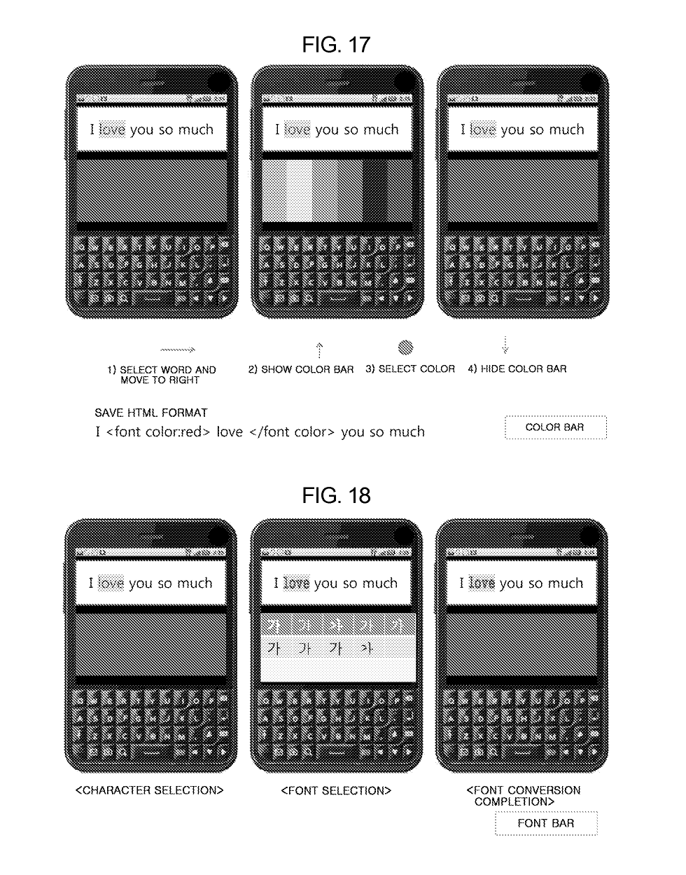

That is, a character makeup terminal 10 and a method of controlling the character makeup terminal 10 according to the present invention are provided, as shown in the attached FIGS. 1 to 18, and are configured to include a display 30 for displaying characters that are entered by a user or are received, as illustrated in FIGS. 1 and 2, and a gesture makeup controller 21 for performing control such that a procedure for making up the characters displayed on the display 30 is performed.

Of course, the character makeup terminal 10 may be provided with a plurality of other physical or software components, and may also be implemented such that a plurality of components applied to a mobile terminal, including elements for inputting characters and inputting and processing various types of manipulation by the user, in addition to the makeup of characters and elements related to the transmitting and receiving of messages when the messages are transmitted to another user, are provided. Furthermore, it is apparent that configuration may be applied and implemented to suit implemented aspects or environments in such a way that part of a plurality of components described in the present invention can also be implemented as physical components, part of the components can be implemented as software components, and part of the components can be operated in combination of physical and software components.

Further, for the types of the character makeup terminal 10 according to the present invention, a mobile terminal that is conveniently usable by the user can be utilized, and, for example, a smart phone, a smart pad, a navigation device, a tablet PC, a Personal Digital Assistant (PDA), and a notebook computer having the specification of a larger size enable operations to be performed while contents displayed on the screen of the display are being viewed. In particular, it is preferable that a touch screen and a component for sensing the motion of the terminal be provided together on the screen of a smart phone, a smart pad, a PDA, a navigation device, etc.

As will be described later, various input schemes for character makeup can be applied to the character makeup terminal in the present invention, in addition to the input of characters from the user. In particular, in the present invention, an input scheme using a touch screen and an input scheme using various motion sensors of the terminal may be used. Such a touch screen input scheme can be implemented such that a predetermined area in the display 30 is set and a touch input signal received from the corresponding area is sensed as an input signal for character makeup, or such that when switching to a touch input waiting state is performed, an input signal for sentimental expression is sensed throughout the entire screen of the display 30.

Further, most of a smart phone, a mobile phone, and another mobile terminal are provided with various motion gesture sensors for sensing the motion of the terminal, such as a gyro sensor, a gravity sensor, an acceleration sensor, and an impact sensor, so that it is possible to sense the motion of the terminal from the motion gesture sensors that are various input sensors. Therefore, the pattern of the motion of the terminal sensed by motion gesture sensors that can be provided using such various sensing schemes is sensed and analyzed.

Character makeup for converting characters displayed on the display 30 is implemented by the character makeup terminal 10 and the method of controlling the character makeup terminal according to the present invention provided in this way. Examples of character makeup may include converting characters (or character strings) in various manners in such a way as to convert the size, font, or color of characters, convert the shape of characters into a wave pattern by changing the height of characters (occasionally changing the lateral space of characters or the like), or convert the sequence of characters. Therefore, the term “character (message) makeup” stated in the present invention is defined and used as the operation of converting characters into a format desired by the user.

In this way, components for performing character makeup on characters displayed on the display 30 will be described below. First, as components for display windows of areas partitioned in the display 30, there can be provided a character display window 31 in which target characters that are targets of character makeup among displayed characters are displayed, and a touch input window 32 in which a touch gesture action is to be sensed according to the user's manipulation so as to make up the target characters for character makeup among the characters displayed in the character display window 31.

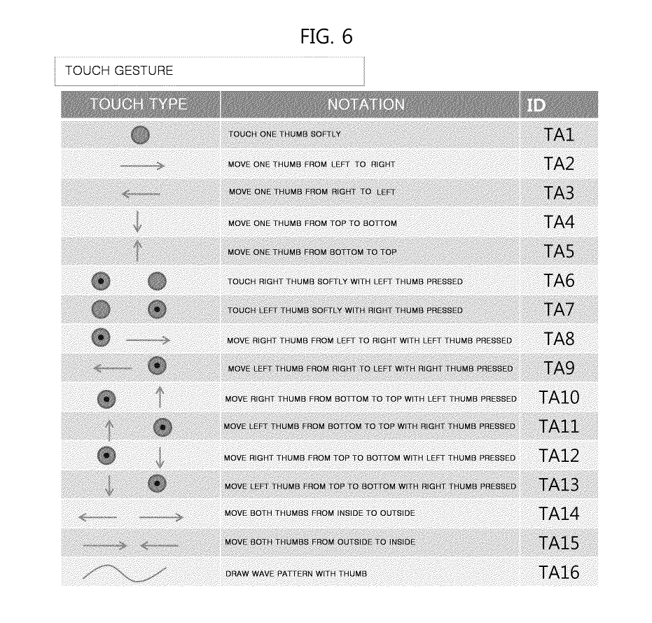

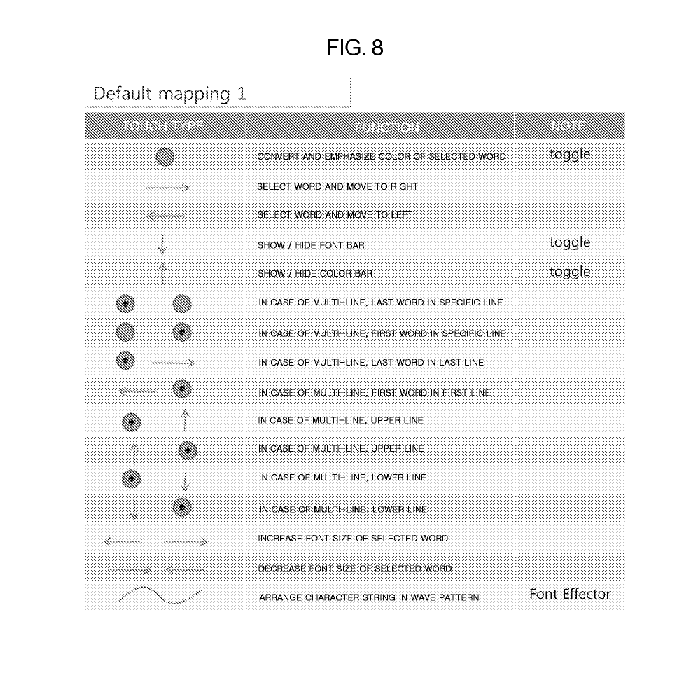

Of course, there may be components related to the sensing and processing of the motion of the terminal, which will be described later, and these components are not typically provided in the display 30, and so components related to the sensing and processing of the terminal motion are not implemented in the display. However, if a component for allowing the user to view details related to the sensing and processing of the terminal motion is required, a display window for the sensing and processing of the terminal motion may be configured as a separate window. Further, user manipulation signals corresponding to various types of touch actions, as shown in FIGS. 6 and 8, are input through the touch input window 32.

As a component for processing character makeup in response to a touch input signal or a terminal motion sensing signal in this way, a gesture makeup controller 21 for performing character makeup that convert target characters displayed in the character display window 31 of the display 30 is provided. Therefore, the gesture makeup controller 21 (so-called gesture-action converter) is configured to read from a data storage unit 24 character makeup setting data that is set in accordance with gesture sensing data corresponding to one or more of touch sensing data and motion sensing data, and to convert target character data depending on the read character makeup setting data.

In the data storage unit 24, character makeup setting data corresponding to the touch input signal that has been input through a touch gesture sensor 22 and a touch gesture recognizer 221 may be stored, so that a character makeup procedure may be performed using the character makeup setting data corresponding to the touch input signal.

Similarly, character makeup setting data corresponding to the terminal motion input signal that has been input through a motion gesture sensor 23 and a motion gesture recognizer 231 is stored, and so a character makeup procedure may be performed using the character makeup setting data corresponding to the terminal motion signal.

In this way, the patterns of the touch input signal and the terminal motion input signal are analyzed, and a gesture-action database (DB) 241 (gesture-action mapping DB) may be configured in which pattern information about character makeup matching the analyzed pattern information is stored. Further, the gesture-action DB 241 may be configured such that pieces of character makeup setting data corresponding to the touch input signal and the terminal motion input signal are stored therein.

Further, along with a font DB 242 for storing font conversion data required to convert the font of characters during the performance of character makeup, the data storage unit 24 may store size conversion data about characters, style conversion data required to convert the style of characters (bold, italic, etc.), character color conversion data required to convert the color of characters, data required for wave pattern conversion, data about scrambling, etc. A process for character makeup is performed by reading the pieces of data.

Below, components for processing input signals based on the user's manipulation for character makeup, such as a touch and a terminal motion, will be described.

First, with regard to the processing of touch input, the touch gesture sensor 22 for sensing the touch input of the user from the touch input window 32, and the touch gesture recognizer 221 for receiving sensing data of the touch input sensed by the touch gesture sensor 22 and calculating touch gesture sensing data by analyzing the pattern of movement trajectory of the touch, are provided.

Further, with regard to the processing of a terminal motion, the motion gesture sensor 23 for sensing the motion of the user and the motion gesture recognizer 231 for receiving the sensing data of the motion sensed by the motion gesture sensor 23 and calculating motion gesture sensing data by analyzing the pattern of the movement trajectory of the motion, are provided. As the types of motion sensors, various types of motion gesture sensors for sensing the motion of the terminal, such as a gyro sensor, a gravity sensor, an acceleration sensor, and an impact sensor, are provided in most terminals, such as a smart phone, a mobile phone, or other types of mobile terminals.

Further, as described above, the data storage unit 24 is provided in which gesture sensing data including one or more of the touch gesture sensing data and motion gesture sensing data is stored, and in which character makeup setting data set in accordance with the gesture sensing data is stored.

Furthermore, the character display window 31 displays target characters among a displayed character string as target characters converted by the gesture makeup controller 21. Further, the touch input window 32 may be implemented to be located either in part of the display area of the display 30 or in the entire display area of the display 30.

Further, the user can make touch input in various manners, as illustrated in FIG. 6, through the touch input window 32, so that character makeup can be implemented in various manners.

Then, depending on the circumstances, it is possible for the touch input window 32 to disappear or decrease during the procedure of entering or revising a character, and, instead, another operation, such as entering a character using a keypad 34 or taking a picture, can be performed, and for this, the touch input window 32 may be converted.

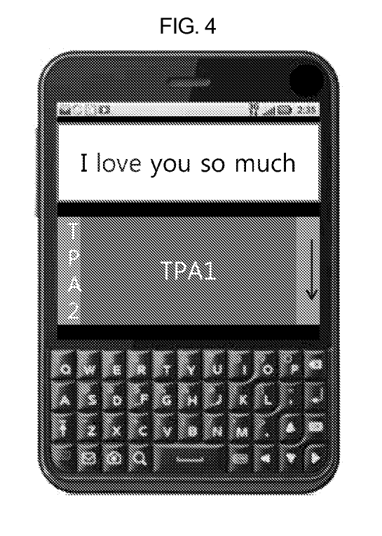

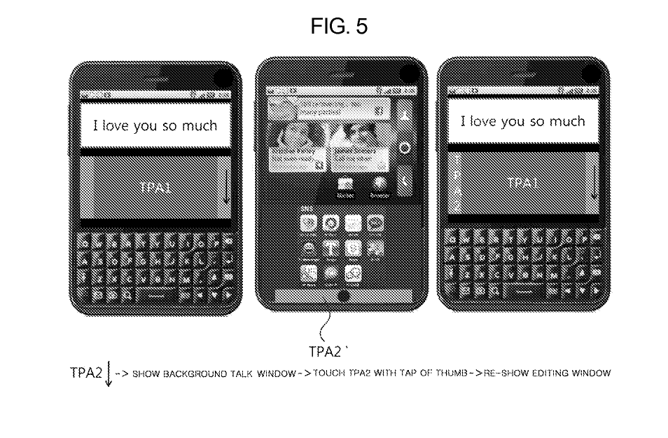

For this operation, a touch input hiding area 322, TPA2 for preventing an activated touch input window 32, TPA1 from being displayed on the display 30 by deactivating the activated touch input window may be provided in the display area of the display 30, as shown in FIGS. 4 and 5.

Further, a touch input window active area 321, TPA2′ causing the touch input window 32 and TPA1 for character makeup of target characters to be activated may be provided.

Then, in a state in which the touch input window 32, TPA1 disappears in response to an input signal made through the touch input hiding area 322, TPA2 (for example, a descending touch input signal), the keypad 34 may appear to be magnified, various editing screens may be displayed, or various menu icons may be displayed, or messages that are transmitted or received or characters that are currently being written using a memo function may appear, as shown in FIG. 5(b). Further, in order to reactivate the touch input window 32, TPA1 for character makeup, the touch input window 32 appears in response to an input signal through the touch input window active area 321, TPA2′ (for example, an input signal pressed with a tap). In this way, the touch input window 32 for touch input is desirably utilized, thus enabling character makeup to be conveniently performed.

In addition, when made-up characters created by the character makeup terminal 10 according to the present invention are used for message transfer, components for transmitting and receiving the corresponding text messages may be provided. That is, a message conversion unit 29 for transferring characters displayed in the character display window 31 may be provided. Further, a transfer window 33 for receiving a signal causing characters to be transferred by the message conversion unit 29 is configured, so that the user selects the transfer window 33 and transfers made-up messages. Furthermore, messages received from other users may be processed by a reception unit 28, so that the messages are displayed on the screen of the display 30, as shown in FIGS. 1 and 2.

Furthermore, when the length of a text message that is transferred is long, as in an example of the mark-up language of a shortened transfer language shown in FIG. 10, a mark-up converter for converting the text message into an abbreviated transfer language is provided. Therefore, since the abbreviated transfer language is used, a burden on message transfer is reduced.

Below, detailed components of a method of controlling the character makeup terminal 10 according to the present invention having the above configuration will be described.

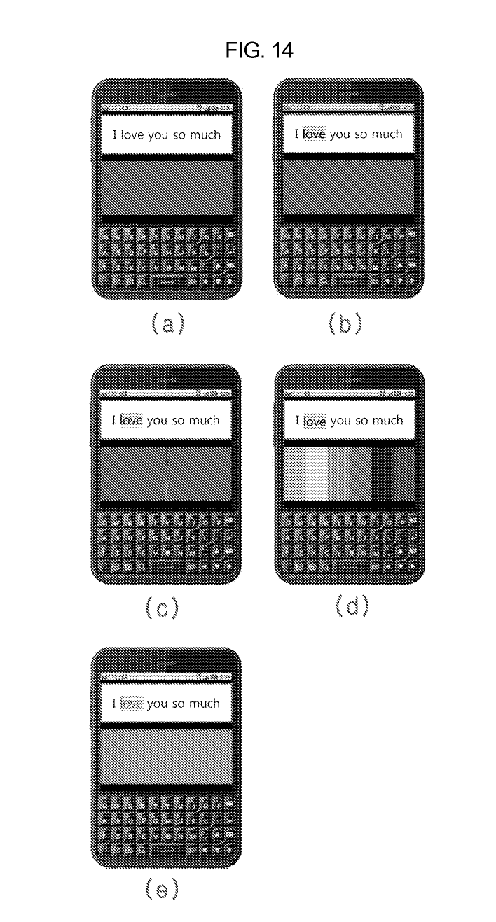

First, prior to character makeup, the character display step S11 of displaying characters, including target characters that are targets of character makeup, on the display 30, as shown in FIG. 14(a), may be performed. In this way, at the character display step, characters, sentences, character strings, or the like are displayed in the character display window 31 of the display 30 via various input schemes, such as a scheme using the keypad 34 enabling touch input to be made on the display 30, a scheme using a separate keypad, or a scheme for inputting a sentence copied from other sentences.

Further, as shown in FIG. 14(b), the conversion target selection step S12 of storing information about the selection of target characters that are targets of character makeup among characters displayed on the display 30 in the DB 24 is performed. This conversion target selection step may be configured such that when the display 30 supports touch input, the user can set the corresponding sentence by dragging the sentence using his or her finger. Alternatively, a desired character may also be selected in a search manner or the like.

After the target characters have been selected as characters, a character string, or a sentence from sentences or character strings in this way, the step of performing character makeup on the target characters, such as the corresponding characters, character string, or sentence, is performed. That is, after the corresponding characters have been selected, as shown in FIG. 14(c), a gesture sensing data storage step S20 is performed where gesture sensing data, including one or more of touch gesture sensing data sensed by the touch gesture sensor 22 and motion gesture sensing data sensed by the motion gesture sensor 23, is stored in the data storage unit 24.

In greater detail, at the gesture sensing data storage step S20, the gesture sensing data, including one or more of touch gesture sensing data sensed by the touch gesture sensor 22 and obtained by analyzing the pattern of the movement trajectory of a touch using the touch gesture recognizer 221 and motion gesture sensing data sensed by the motion gesture sensor 23 and obtained by analyzing the pattern of the movement trajectory of a terminal motion using the motion gesture recognizer 231, is stored in the data storage unit 24. For example, FIG. 14 illustrates a character makeup procedure for the color conversion of characters. In FIG. 14(c), touch input moved in a direction from bottom to top to enable a color bar to appear may be made, as shown in FIG. 8 and FIG. 6.

Thereafter, a character makeup setting data reading step S30 is performed at which character makeup setting data, set in accordance with the gesture sensing data, is read from the data storage unit 24. That is, at the character makeup setting data reading step S30, with respect to the gesture sensing data including one or more of the touch gesture sensing data and the motion gesture sensing data, character makeup setting data set in accordance with the predetermined pattern of the movement trajectory of the touch or the terminal motion is read from the data storage unit 24.

Then, in the example of character makeup for the color conversion of characters shown in FIG. 14, according to the read character makeup setting data, the corresponding gesture sensing data is determined to be character makeup data for the color conversion of characters. The procedure of showing character makeup examples, such as color examples as shown in FIG. 14(d), on the display may be further performed on the character makeup setting data related to the color conversion of characters. Of course, in the case of character makeup for the color conversion of characters in this way, color examples are displayed. In other cases, the procedures of displaying change examples for character makeup may be additionally performed in such a way as to display character font examples in the case of character font conversion, display character size examples in the case of character size conversion, display character style examples in the case of character style conversion, or display change examples of a character wave pattern in the case of conversion into the character wave pattern.

Further, since FIG. 14 is related to the color conversion of characters, if the user selects a desired color from among color examples illustrated in FIG. 14(d), input data about the selected color may be stored and processed. That is, the character makeup data conversion step S40 of converting character data depending on the character makeup setting data read at the character makeup setting data reading step is performed by the gesture makeup controller 21.

Thereafter, the converted data display step S50 of processing the converted character data so as to display the character data on the display unit 30 is performed by the makeup display data processing unit 25 (message makeup device).

Then, referring to the example of character makeup for color conversion in FIG. 14, the state in which the color of corresponding target characters is changed as shown in FIG. 14(e) and character makeup has been performed is displayed in the character display window 31 of the display 30. Characters converted in other character makeup steps may be displayed in a converted state.

Referring to the character makeup conversion step S40 based on various embodiments of character makeup implemented by the character makeup terminal 10 and the method of controlling the character makeup terminal according to the present invention, the following detailed character makeup steps can be performed.

First, various types of character makeup steps, such as the character color conversion step of converting and processing the color of target characters, the character font conversion step of converting and processing the font of target characters, the character size conversion step of converting and processing the size of target characters, the character style conversion step of converting and processing the style of target characters, the character string wave pattern conversion step of converting and processing the shape of a character string including target characters into a wave pattern, and the scrambling step of randomly arranging the sequence of words by scrambling and processing a character string including target characters, may be included and performed.

Further, among the data conversion steps for character makeup, the detailed procedure of the character color conversion step of converting and processing the color of target characters is configured such that, at the gesture sensing data storage step, gesture sensing data required to convert and process the color of target characters is stored in the data storage unit 24, and such that if the gesture sensing data required to convert the color of target characters is input by the gesture makeup controller 21, a color selection window required to select and input the color of the characters is displayed on the display 30.

Furthermore, among the data conversion steps for character makeup, the detailed procedure of the character font conversion step of converting and processing the font of target characters is configured such that at the gesture sensing data storage step, gesture sensing data required to convert and process the font of target characters is stored in the data storage unit 24, and such that if the gesture sensing data required to convert the font of target characters is input by the gesture makeup controller 21, a font selection window required to select and input a font is displayed on the display 30. The procedure of selecting a color or a font is included in this way, so that the user can select a desired character color or font, thus further increasing the user's satisfaction.

Next, when the function of transmitting and receiving messages is included in the character makeup terminal 10, the procedure of transmitting and receiving text messages may be further included. That is, a character makeup data transfer step S60 may be performed at which the converted character data is displayed on the display 30, and at which a selection input signal on the transfer window is processed and the character data is converted into and transmitted as text message data by the message conversion unit 29.

Further, the character makeup data transfer step may be configured to include the mark-up processing step of converting the text message data converted from the character data for character makeup into an abbreviated transfer language, as illustrated in FIG. 10.

Since the amount of character transfer data that is transferred at the mark-up processing step is reduced, transfer efficiency can be further improved.

An embodiment of character makeup performed by the character makeup terminal 10 according to the present invention provided in this way will be described in detail below with reference to the attached drawings.

The character (message) makeup terminal 10 and the method of controlling the character (message) makeup terminal 10 according to the present invention are intended to implement character (message) makeup technology on characters written on a terminal, such as a smart phone, a tablet PC, a netbook, a notebook, or a desktop computer, and text messages that are transmitted or received via the terminal, as shown in FIGS. 1 to 16. In particular, the character makeup terminal is more preferably implemented as a mobile terminal.

(A) Basic Structure and Display Configuration

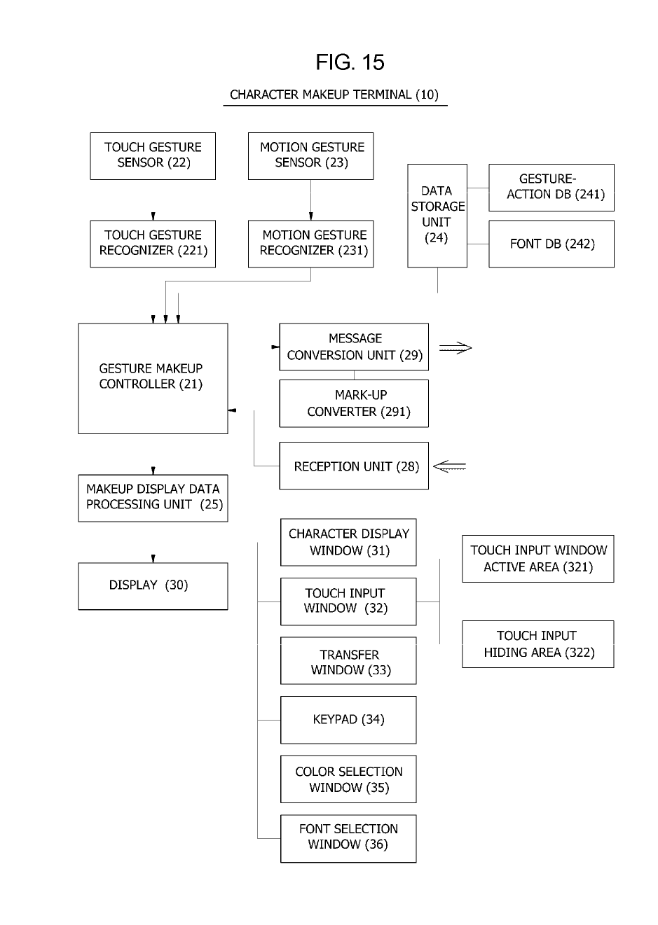

In order to implement this, the system proposed in the present invention includes, as shown in FIG. 15, a touch gesture sensor 22, a motion gesture sensor 23 such as a gyro sensor, a gesture makeup controller 21, a data storage unit 24 capable of including a gesture-action mapping DB or the like, a makeup display data processing unit 25, and a display 30. The principal content of the present invention includes the device components of character makeup for converting characters, and may be implemented to include various other related auxiliary components for writing and displaying characters. These detailed components are not especially described, but aspects of components that are generally provided and implemented can be applied to the present invention.

Further, the components of the present invention may be implemented by logical and physical processing components and data storage components of a mobile terminal, such as a smart phone, and may also be configured to include and execute the internal components of a PC, such as a desktop computer or a notebook computer, the components of a network over which a plurality of PCs are connected, or a plurality of servers connected via the network, such as the Internet. That is, the components of the present invention may be configured as elements named ‘˜unit’, ‘˜engine’, ‘˜module’, ‘˜device’, ‘˜database’, ‘˜DB’, and ‘storage unit’, and denote components for processing or storing specific functions or operations, such as physical part components for processing or storing data by those elements, the components of a processing device, logical processing components, the components of a processor, and the components of a control flow. In addition to these components, various types of components, such as hardware components, software components, or complex combinations of hardware and software components, may be provided and implemented. These components may be interpreted as being limited to any one type, but may also be configured as physical components that can be applied, operated, and implemented within the typical technical items of the fields related to general electronics and telecommunications, or software related to the physical components. The forms or coupling relations of the components may be set and implemented in conformity with situations that are realized.

Meanwhile, those internal modules are operated by the configuration of a display that is intuitive to the user, and an example of a character and message input device presented in the present invention can be provided, as shown in FIG. 4. That is, the configuration of an interface as shown in FIG. 4 can be derived from the fact that many people who use a character and message keypad are called the “thumb generation”. The interface is composed of (1) a character display window 31, (2) a touch panel area 1 32, TPA1, (3) a touch panel area 2 TPA2, (4) a keypad 34, etc., and is configured so that the user can easily touch the keypad using his or her thumb.

Further, a detailed description of those components will be made as follows:
(1) Character display window: the display of input characters
(2) Touch panel area 1 (TPA1) (touch input window 32): touch input for character makeup
(3) Touch panel area 2 (TPA2, TPA2′): the input of character display window hiding/showing commands
(4) Keypad: Character String Input Command

In the above configuration, the reason for needing the touch panel area 2 is to allow the user to use the area when desiring to easily view a background while entering a character or a message, and this function is shown in FIG. 5. That is, when the touch panel area 2 (touch input hiding area 322, TPA2) is touched, the character display window, the touch input window, etc. disappear, and a character currently being entered or a messenger currently being viewed appears on the screen. In this case, the touch input window active area 321, TPA2′ moves to a lower portion of the display. When the touch input window active area 321 is touched, the touch input window 32 reappears.

(B) Embodiment of Definition of Touch Gesture Sensor

For character makeup for changing characters, a touch gesture must have a pattern that can be easily input using two thumbs (of right and left hands), and must be able to be easily implemented in the touch area of the touch input window 32, as shown in FIG. 6. In particular, character makeup is implemented using the input of a touch gesture on the touch panel area 1 TPA1 of the touch input window 32. The touch gestures or the like proposed in the present invention can be basically composed of a total of 16 gestures, as shown in FIG. 6. Of course, various touch patterns (an emoticon shape, a triangular shape, or a letter shape) can be implemented, but the present invention can basically define and utilize 16 gestures so as to use simple functions provided by an Android touch manager, and it is apparent that more types of touch pattern rules for character makeup can be defined and implemented.

(C) Embodiment of Definition of Motion Gesture Sensor such as Gyro Sensor

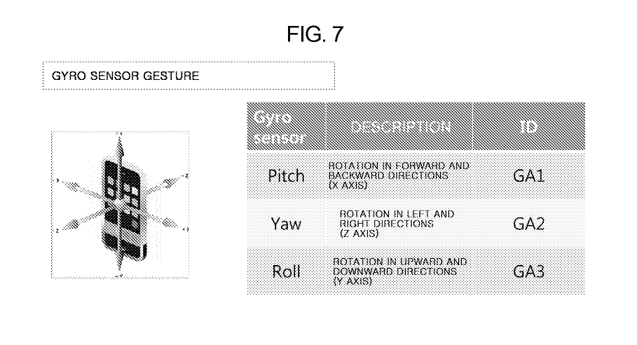

For intuitive use by the user, the basic operations of terminal motion sensors desired to be used in the present invention are a pitch, a yaw, and a roll. As shown in FIG. 7, simple specifications of the terminal motion gesture sensor are defined.
(1) Pitch: rotation in forward and backward directions (X axis)—ID: GA1
(2) Yaw: rotation in left and right directions (Z axis)—ID: GA2
(3) Roll: rotation in upward and downward directions (Y axis)—ID: GA3

(D) Description of Modules of Message Makeup Device

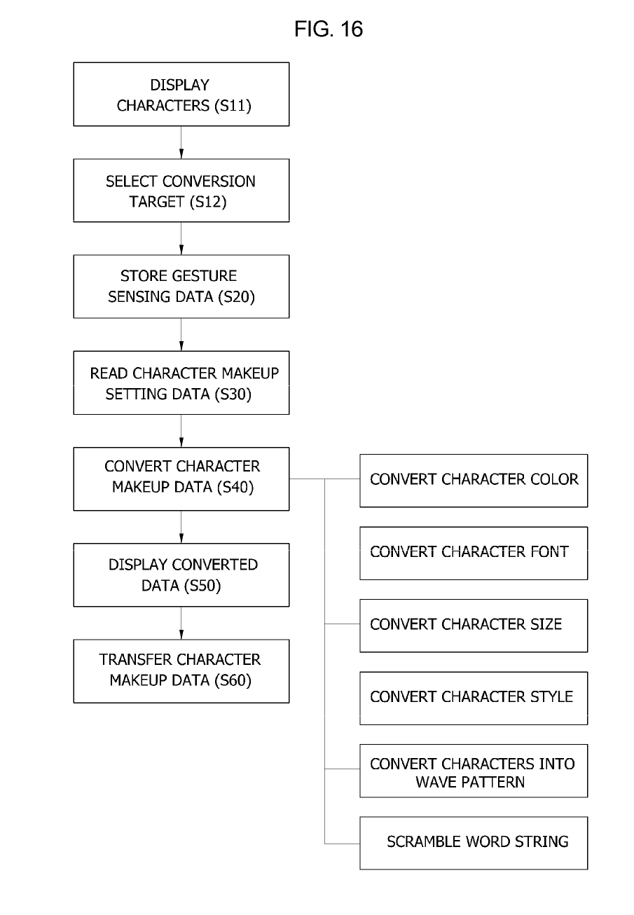

Based on the above descriptions, as shown in FIGS. 15 and 16, the basic structure of the character makeup terminal and the method of controlling the terminal can be implemented as follows, and the functions of individual modules are described below.

(1) Touch Gesture Sensor 22 and Touch Gesture Recognizer 221

As shown in FIG. 4, the patterns of touch gestures of two thumbs (or two fingers), input through the area of the touch input window 32 (TPA1, TPA2, TPA2′) and the touch gesture sensor 22, are analyzed, and the touch gesture recognizer 221 recognizes and determines touches to be Touch Actions (TA 1˜6) shown in FIG. 6. Touch recognition can be implemented using basic algorithms provided by the Operating System (OS) of a typical mobile terminal, such as a smart phone.

(2) Motion Gesture Sensor 23 and Motion Gesture Recognizer 231

When the terminal is rotated, and a yaw, a pitch and a roll are sensed by the motion gesture sensor 23, such as a gyro sensor, the motion gesture recognizer 231 shown in FIG. 7 can analyze terminal motion sensing signals and then recognize those sensing signals as motion sensing actions (gyro actions 1˜3).

(3) DB (Gesture-Action Mapping DB)

The sensing data and character makeup setting data are stored in the gesture-action mapping DB including a 1:1 mapping DB so that actions (TA1˜TA16 and GA1˜GA3 shown in FIGS. 6 and 7) generated by modules, such as (1) the touch gesture recognizer and (2) the motion gesture recognizer, can be converted into commands for character makeup.

(4) Gesture Makeup Controller 21

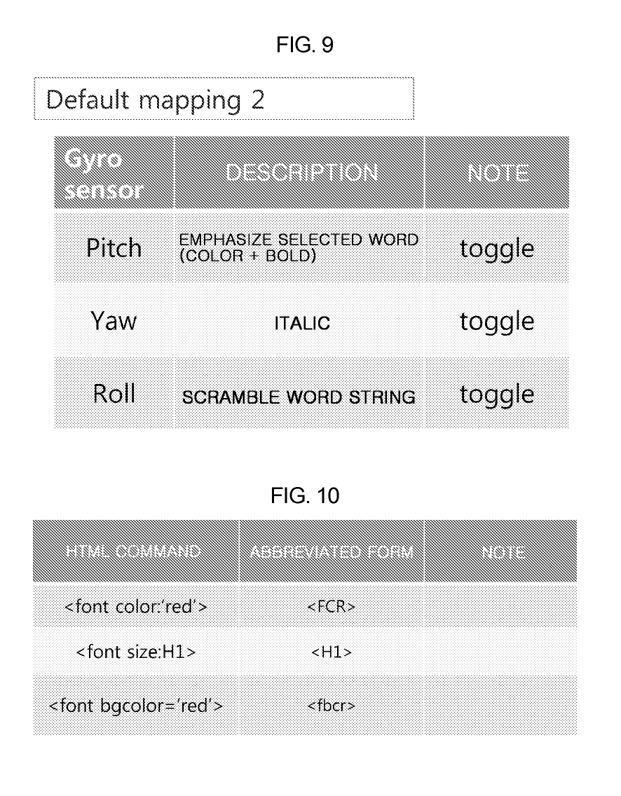

Data sensed by actions (TA1˜TA16 and GA1˜GA3 shown in FIGS. 6 and 7) occurring due to the pieces of data stored in (3) the DB (gesture-action mapping DB) and predetermined action data analyzed from the sensed data are converted into character makeup commands, as shown in FIGS. 8 and 9.

(5) Character Display Data Processor

The character makeup terminal can receive character data obtained by converting the control data and target characters of (4) the gesture makeup controller 21 via character makeup, and can display the made-up characters on the display or perform the operation of editing the characters. A data processing procedure for character makeup, corresponding to the data sensed by the touch gesture sensor or the motion gesture sensor, is performed on data of target characters displayed on the display, thus enabling the character data to be displayed in a predetermined display state.

(6) Font DB

In this DB, basically provided font data may be stored or, alternatively, various types of font data that have been input by each individual user and that are implemented on a smart phone, a mobile terminal, or the like may be stored.

(7) Keypad

This is a pad window for entering a character string.

(8) Display

This may be a display interface window for showing a made-up character string, and may be composed of a screen window basically provided by the terminal and windows executed as respective steps are performed in the present invention.

(9) Message Mark-Up Language Converter

In the present invention, character makeup may be implemented using a HyperText Markup Language (HTML) command set. Therefore, when conversion is performed by adding an HTML command set to a made-up character string, the effects of character makeup and message character makeup can be produced on terminals such as all smart phones and desktop computers that support HTML.

That is, HTML uses commands that are clear and easily understandable so as to describe effects. For example, HTML can be written as <font color: red>. In this case, an SNS using the Internet is not greatly influenced, but existing messengers basically support text of only 80 letters, so that available resources are excessively used, and thus actually transferred information may be limited. Therefore, in the present invention, information is transferred using a simplified version of a command transfer scheme for HTML commands. For example, as shown in FIG. 10, this scheme can be implemented such that <font color: ‘red’> is converted into <FCR>, thus reducing the amount of information transferred.

(E) Definition and Implementation of Types of Character String Makeup

The present invention is configured to provide components for character makeup that can be implemented using simple touches or gestures made by the motion sensing of a gyro sensor or the like. A usage method in the present invention is executed by recognizing a touch or the user's motion gesture to enable the user's manipulation to be simply performed. Accordingly, if the manipulation is complicated, the user may not use character makeup, so that the present invention is configured to be simply executed. The types of makeup of message character strings according to the present invention can be implemented, as illustrated in FIGS. 8, 9, and 11 to 13.
(1) Conversion of the color of characters in character string
(2) Conversion of the size of characters in character string
(3) Conversion of the font of characters
(4) Designation of the font style of character string (bold, italic, or the like)
(5) Conversion of arrangement of character string into wave pattern in transverse direction
(6) Scrambling of word string (rearrangement in irregular sequence)

In this character makeup, a character string is implemented on a word basis, and so default implementation can be performed using basic action elements, such as TA1 to TA3 of FIG. 6. Further, the color and type of fonts can be intuitively selected. Since an input window for wave pattern arrangement or the like is a text editing window, a special method can be provided, and the following methods can be additionally performed in relation to wave pattern arrangement.

(F) Utilization of Color Bar/Font Bar

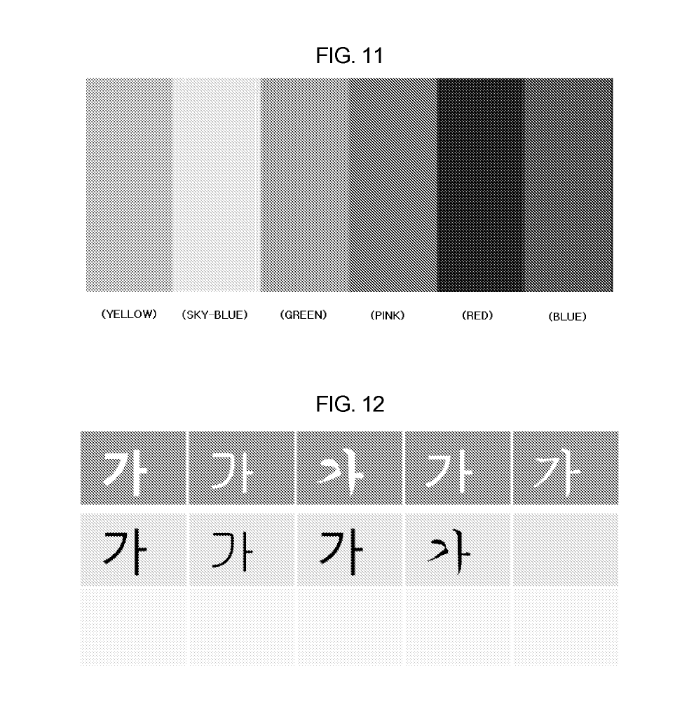

This can be provided such that, in order for the user to easily convert the color and type of fonts, a color bar and a font bar can be utilized. The basic settings of touch gestures may be performed such that a prepared color bar (see the embodiment of FIG. 14) and a prepared font bar appear or disappear by using TA4 or TA5 of FIG. 6. The color bar may be designated as a default to appear or enable user editing, and the font bar may be used by searching currently installed fonts. Examples of the font bar and the color bar are shown in FIGS. 11 and 12, and FIG. 14 shows a procedure for converting the color of ‘love’ in the message ‘I love you so much’ into red by using the color bar. Even if the color bar or the font bar appears, a touch command can be input in the same manner. For this function, the color bar or the font bar may be configured to be processed as images. Further, configuration in which when the color bar and the font bar are not used, a basic color and a basic font (default) are defined and emphasized may also be implemented.

(G) Arrangement of Character String in Wave Pattern

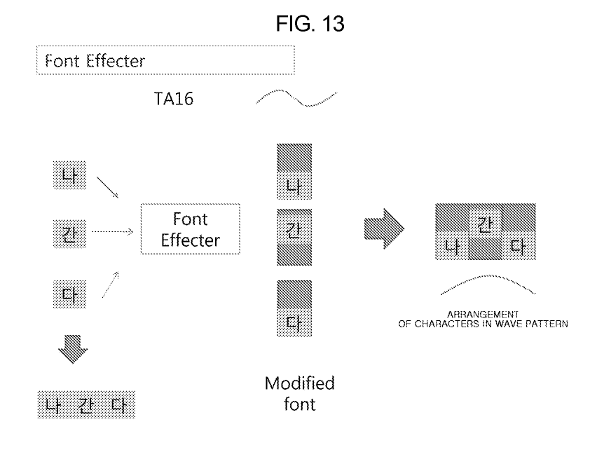

A message input window is basically a text window, so that graphical effects cannot be assigned. Therefore, this function can be performed such that a modified extended font obtained by extending a basic font is used to implement the arrangement of a wave pattern. That is, in the drawing illustrated in FIG. 13, the aspect of implementation of a wave pattern is shown. Characters are arranged on images of a modified font that is vertically larger than a typical basic font depending on the height information of the wave pattern. Next, when fonts that are modified by executing wave pattern arrangement appear on the message window, the characters are shown as if they were arranged in a wave pattern. This procedure is performed by the character makeup terminal shown in FIG. 15 and, especially, a module for implementing this procedure, is executed by a font effecter.

(H) Scrambling of Word String

The scrambling of a word string is a kind of decoration for fun, is basically operated by GA3, and is intended to transmit words by randomly changing the sequence of the words of an input word string. For example, the scrambling of a word string is performed such that the message ‘I love you so much’ is shown as a format in which the sequence of the arranged characters is modified, such as ‘you so love much I’ by implementing makeup configuration of word string scrambling and then the modified message is transferred. In order to implement such word string scrambling, a random number generator can be provided. That is, the sequence of entered character words may be changed by the random number generator connected to a word string scrambling processing unit, and the arrangement of the sequence of words of a character string may be changed depending on the alignment sequence of the random number generator.

The present invention having the above configuration is intended to provide a character makeup terminal and a method of controlling the terminal using the detection of touch and motion gestures, and has excellent advantages in that characters are written in accordance with a user's sentiment, and written character makeup messages are definitely transferred or are transferred with the current sentiment contained in the messages by allowing the user to change the font, color, size, style, or position of characters.

Further, other advantages of the present invention are that when text message makeup technology is executed on messages that are sent, an interface window is configured in consideration of the small window display of a terminal, such as a smart phone or a desktop computer, and that various types of message makeup are implemented to prevent the execution of complicated computation and the consumption of excessive memory or the like, thus improving the convenience of use.

Although the preferred embodiments of the present invention have been described in detail, these embodiments are described to easily implement the present invention by those skilled in the art, so that the technical spirit of the present invention should not be limitedly interpreted by the description of the embodiments.

1. A method of controlling a character makeup terminal, comprising:
a gesture sensing data storage step of storing gesture sensing data including one or more of touch gesture sensing data sensed by a touch gesture sensor and motion gesture sensing data sensed by a motion gesture sensor, in a data storage unit;
a character makeup setting data reading step of reading character makeup setting data, set in accordance with the gesture sensing data, from the data storage unit;
a character makeup data conversion step of a gesture makeup controller converting character data depending on the character makeup setting data read at the character makeup setting data reading step; and
a converted data display step of a makeup display data processing unit processing converted character data so as to display the character data on a display.

2. A method of controlling a character makeup terminal, comprising:
a gesture sensing data storage step of storing gesture sensing data including one or more of touch gesture sensing data sensed by a touch gesture sensor and obtained by analyzing a pattern of a movement trajectory of a touch using a touch gesture recognizer and motion gesture sensing data sensed by a motion gesture sensor and obtained by analyzing a pattern of a movement trajectory of a terminal motion using a motion gesture recognizer, in a data storage unit;
a character makeup setting data reading step of reading character makeup setting data, set in accordance with a predetermined pattern of the movement trajectory of the touch or a predetermined pattern of the movement trajectory of the terminal motion, from the data storage unit with respect to the gesture sensing data including one or more of the touch gesture sensing data and the motion gesture sensing data;
a character makeup data conversion step of a gesture makeup controller converting character data depending on the character makeup setting data read at the character makeup setting data reading step; and
a converted data display step of a makeup display data processing unit processing converted character data so as to display the character data on a display.

3. The method of claim 2, further comprising a character makeup data transfer step of displaying the character data on the display and allowing a message conversion unit to convert the character data into text message data and transfer the text message data by processing a selection input signal on a transfer window.

4. The method of claim 3, wherein the character makeup data transfer step comprises a mark-up processing step of converting the text message data converted from the character data for character makeup into an abbreviated transfer language.

5. The method of claim 2, further comprising:
a character display step of displaying characters including a target character that is a target of character makeup on the display; and
a conversion target selection step of storing information about selection of the target character that is the target of character makeup among the characters displayed on the display in a DB.

6. The method of claim 2, wherein the character makeup data conversion step comprises one or more of:
a character color conversion step of converting and processing a color of a target character;
a character font conversion step of converting and processing a font of the target character;
a character size conversion step of converting and processing a size of the target character;
a character style conversion step of converting and processing a style of the target character;
a character string wave pattern conversion step of converting and processing a shape of a character string including the target character into a wave pattern; and
a scrambling step of randomly arranging a sequence of words by scrambling and processing a character string including the target character.

7. The method of claim 2, wherein:
the character makeup data conversion step comprises a character color conversion step of converting and processing a color of a target character,
the gesture sensing data storage step is configured such that gesture sensing data required to convert and process the color of the target character is stored in the data storage unit, and
when the gesture sensing data required to convert the color of the target character is input by the gesture makeup controller, a color selection window required to select and input a color of characters is displayed on the display.

8. The method of claim 2, wherein:
the character makeup data conversion step comprises a character font conversion step of converting and processing a font of a target character,
the gesture sensing data storage step is configured such that gesture sensing data required to convert and process the font of the target character is stored in the data storage unit, and
when the gesture sensing data required to convert the font of the target character is input by the gesture makeup controller, a font selection window required to select and input a font is displayed on the display.

9. A character makeup terminal comprising:
a character display window for displaying a target character that is a target of character makeup among displayed characters; and
a touch input window for sensing a touch gesture action via manipulation of a user so as to perform character makeup on the target character that is the target of character makeup among the characters displayed on the character display window.

10. A character makeup terminal comprising:
a gesture makeup controller for performing character makeup to convert a target character displayed on a character display window of a display, wherein the gesture makeup controller reads character makeup setting data, set in accordance with gesture sensing data corresponding to one or more of touch sensing data and motion sensing data, from a data storage unit, and converts character data of the target character depending on the read character makeup setting data.

11. The character makeup terminal of claim 10, further comprising:
a touch gesture sensor for sensing a touch input of a user from a touch input window;
a touch gesture recognizer for receiving sensing data of the touch input sensed by the touch gesture sensor, and calculating touch gesture sensing data by analyzing a pattern of a movement trajectory of the touch;
a motion gesture sensor for sensing a motion of the user;
a motion gesture recognizer for receiving sensing data of the motion sensed by the motion gesture sensor, and calculating motion gesture sensing data by analyzing a pattern of a movement trajectory of the motion; and
a data storage unit for storing gesture sensing data including one or more of the touch gesture sensing data and the motion gesture sensing data, and storing character makeup setting data set in accordance with the gesture sensing data.

12. The character makeup terminal of claim 10, wherein the character display window is configured such that a target character of a displayed character string is displayed as a target character converted by the gesture makeup controller.

13. The character makeup terminal of claim 11, wherein the touch input window is located in part of a display area of the display, or in an entire display area of the display.

14. The character makeup terminal of claim 13, further comprising:
a touch input window active area for activating the touch input window for character makeup of the target character; and
a touch input hiding area for preventing an activated touch input window from being displayed on the display by deactivating the activated touch input window.

15. The character makeup terminal of claim 10, further comprising:
a message conversion unit for transferring a character displayed on the character display window; and
a transfer window for receiving a signal causing the character to be transferred by the message conversion unit.
